(19) United States
(12) Patent Application Publication
(10) Pub. No.: US 2014/0304170 A1
(43) Pub. Date: Oct. 9, 2014

(54) REMOTE CREDIT ISSUANCE SYSTEM

(71) Applicants: Mark Alan Spotanski, Omaha, NE (US); Michael Philip O'Neil, Carter Lake, IA (US); Jeffrey Cecil Weeks, Papillion, NE (US); James Anthony Weeks, Papillion, NE (US); Steven Charles Clawson, Neola, IA (US); Shawn Christopher Ippensen, Omaha, NE (US); Emanuel Hayes, Omaha, NE (US)

(72) Inventors: Mark Alan Spotanski, Omaha, NE (US); Michael Philip O'Neil, Carter Lake, IA (US); Jeffrey Cecil Weeks, Papillion, NE (US); James Anthony Weeks, Papillion, NE (US); Steven Charles Clawson, Neola, IA (US); Shawn Christopher Ippensen, Omaha, NE (US); Emanuel Hayes, Omaha, NE (US)

(73) Assignee: FIRST NATIONAL OF NEBRASKA, INC., OMAHA, NE (US)

(21) Appl. No.: 14/203,963

(22) Filed: Mar. 11, 2014

Related U.S. Application Data
(60) Provisional application No. 61/820,644, filed on May 7, 2013.
(60) Provisional application No. 61/791,946, filed on Mar. 15, 2013.

(51) Int. Cl. G06Q 20/34; G06Q 20/38

(52) U.S. Cl. CPC G06Q 20/354; G06Q 20/3829; G06Q 40/025
USPC 705/71; 705/64

(57) ABSTRACT

Systems and methods for establishing a credit account are disclosed. The systems and methods may receive a first encrypted payload comprising application data associated with a credit application by a credit issuer. The first encrypted payload may be decrypted to provide intelligible application data comprising applicant identifying information. A credit application can be processed using the applicant identifying information and a credit account can be established based on the credit worthiness determined and associated with the applicant. A second encrypted payload comprising credit account information associated with the credit account can then be established and transmitted to a client at the first location.

### CROSS-REFERENCE TO RELATED APPLICATIONS

This application claims priority to U.S. Provisional Application Ser. No. 61/791,946, filed Mar. 15, 2013, and also claims priority to U.S. Provisional Application Ser. No. 61/820,644, filed May 7, 2013, each of which is herein incorporated by reference in its entirety.

### BACKGROUND OF THE INVENTION

The embodiments of the present invention generally relate to systems and methods for producing credit cards or other tokens associated with credit accounts. More particularly, the present disclosure relates to remotely located systems and methods for updating and/or generating cards and other tokens for credit accounts.

Credit issuers such as banks or other financial institutions often partner with other businesses such as retailers to provide branded credit tokens such as credit cards. These cards are linked to credit accounts administered by the financial institution and can carry the partner's branding, such as a retailer logo. These accounts can then used to in administering loyalty programs for the retail partner, facilitate purchases from the retailer and, in some cases, other merchants. Often, the retail partners lack the requisite security, know-how, and information technology resources to permit on-site issuance of permanent cards or other tokens. As a result, temporary cards, or even no card may be issued to the customer thus delaying access to the credit account. It is desirable to give immediate access to the credit account for customers to facilitate on-site purchases.

Accordingly, there is a need for credit issuing systems and methods capable of issuing credit cards and/or other account tokens at locations remote from the financial institution issuing the credit. There is a further need for systems and methods capable of reliably facilitating the issuance of partner branded cards at the partner location.

### SUMMARY OF THE INVENTION

The embodiments of the present invention generally relate to systems and methods for establishing a credit account. The methods of various embodiments of the present invention can include receiving a first encrypted payload comprising application data associated with a credit application by a credit issuer. The application data can be transmitted over the Internet and originate from a first location remote from the credit issuer. The first encrypted payload can be decrypted to provide intelligible application data including applicant identifying information. The credit application can then be processed to determine credit worthiness and, if appropriate, a credit account can be established. A second encrypted payload can be prepared having credit account information associated with the credit account, and the payload can be transmitted to a client at the first location. A client device at the first location can decrypt the second encrypted payload to provide intelligible credit account data and can update, replace, or create a token uniquely associated with the credit account based on the credit account data at the first location.

Other embodiments relate to methods of establishing a credit account that can include the steps of collecting application data associated with a credit application for a credit issuer and transmitting the application data over the Internet from a first location not directly controlled by the credit issuer. The credit issuer can then receive an encrypted payload via the Internet including credit account information associated with a credit account established by the credit issuer based on the application data. The payload can be decrypted to provide intelligible credit account data, and a token associated with the credit account is updated or created based on the credit account data at the first location.

Yet other embodiments relate methods for establishing a credit account including the steps of receiving a first encrypted payload comprising application data associated with a credit application by a credit issuer, the application data being transmitted over a network and originating from a first location remote from and not directly controlled by the credit issuer. The first encrypted payload can be decrypted to provide intelligible application data including applicant identifying information. A credit application can be processed using the applicant identifying information to determine credit worthiness and, if appropriate, a credit account can be established on the credit worthiness determined and associated with the applicant. A second encrypted payload can be prepared including credit account information associated with the credit account established and transmitted to a client at the first location over the Internet. A client device at the first location can then decrypt the second encrypted payload to provide intelligible credit account data and can update, replace, or create a token uniquely associated with the credit account.

Further embodiments relate to systems for remotely issuing tokens associated with credit accounts. The system may include one or more input devices configured to capture applicant information at a location remote to the credit issuer. The input devices may have a network connection with a local network including a router that is in communication with a wide area network or the Internet. A client device can also be provided and, in some such embodiments, be on the same local area network as the input devices. A credit issuer server can be provided and accessible via the Internet and is configurable to receive credit application information and provide it to a credit processing engine for processing the application data and automatically determining credit worthiness. A credit issuing engine may communicate with a mainframe or other data system for establishing a new, or updating an existing, credit account. The relevant new information relating to the credit account may be transmitted from the issuer engine to the client device which is configured to create or update a token associated with the credit account.

Unless otherwise expressly stated, it is in no way intended that any embodiment set forth herein be construed as requiring that its steps or process be performed in a specific order. This holds for any possible non-express basis for interpretation, including matters of logic with respect to arrangement of steps or operational flow, plain meaning derived from grammatical organization or punctuation, or the number or type of embodiments described in the specification.

### BRIEF DESCRIPTION OF THE DRAWINGS

The accompanying drawings, which are incorporated in and constitute part of this specification, illustrate embodiments of the invention, and together with the description, serve to explain the principles of the invention. The embodiments described in the drawings and specification in no way limit or define the scope of the present invention.

FIG. 1 is a diagram of the remote card issue system of one embodiment of the present invention.

FIG. 2 is a diagram of the remote card issue system of another embodiment of the present invention.

FIG. 3 is a flow diagram for the method of one embodiment of the present invention.

FIG. 4 is a diagram of the remote card issue system of another embodiment of the present invention

The present invention has been illustrated in relation to embodiments which are intended in all respects to be illustrative rather than restrictive. Those skilled in the art will realize that the embodiments of the present invention are capable of many modifications and variations without departing from the scope of the present invention.

### DETAILED DESCRIPTION OF THE INVENTION

The various embodiments of the present invention provide systems, apparatuses, and methods for establishing credit or debit accounts and for updating or generating tokens associated with those accounts at a location remote to the issuer. The embodiments of the present invention can therefore get cards or other tokens into the hands of customers quickly and at any location. For example, a remote card issue system can be deployed at or near retail locations or sporting events where a potential customer can apply for a credit card, be approved for a card, and then quickly receive a printed plastic card ready for use. In various embodiments the remote card issue systems and methods can comply with applicable Payment Card Industry (“PCI”) standards, such as the PCI Data Security Standard (“PCI DSS”).

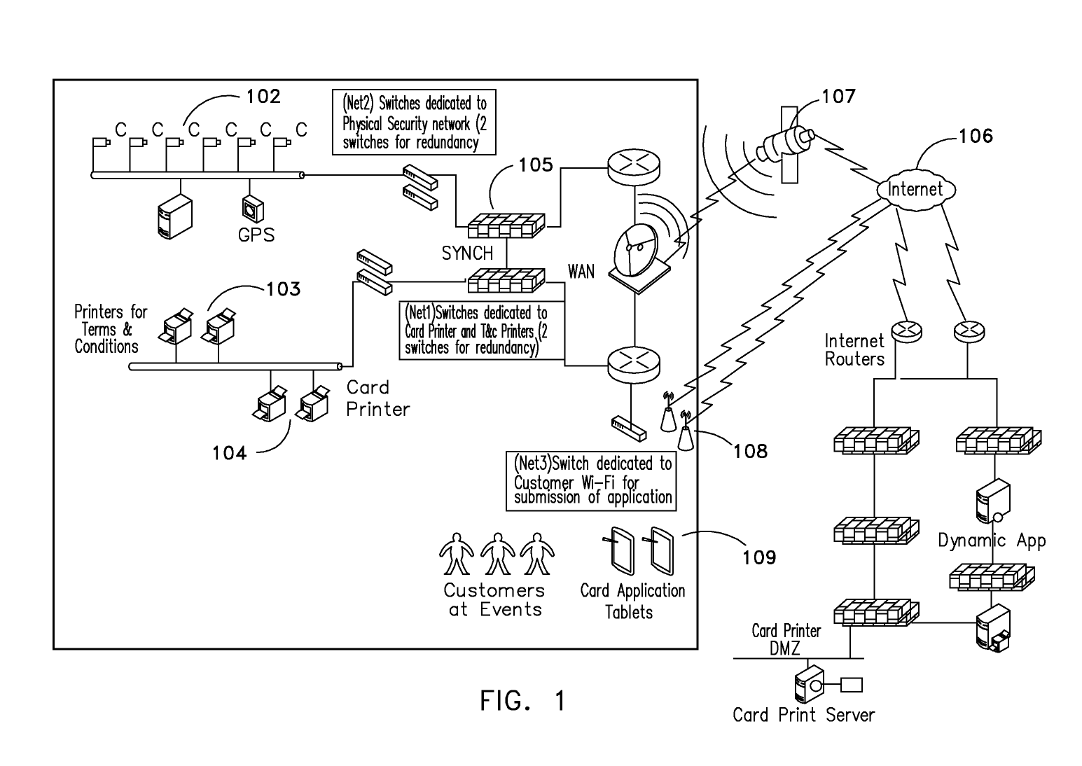

The remote card issue system of one embodiment is shown in FIG. 1. As shown in FIG. 1, the mobile card issue system 101 can include various hardware and software components that are used to process and print cards in accordance with PCI standards. For example, security devices such as video cameras 102 coupled to a digital video recorder can be used to provide physical security. Printers 103 for terms and conditions and card printers 104 can be coupled to a local-area network. One or more switches 105 can be used to couple devices in the mobile container to a wide-area network such as the Internet 106. Communication between the devices in the mobile card issue system 101 and the WAN 106 can be carried out using any suitable network connection, including wired and/or wireless network connections. As shown in FIG. 1, embodiments of the invention may use a satellite 107 and/or cellular network 108, for example, to communicate card-related data over a WAN 106. Accordingly, the mobile card issue system 101 can comply with applicable PCI standards.

In some embodiments, a customer at an event or third-party retail location, for example, can use a mobile device 109 such as a smart phone, a tablet such as an APPLE iPad, or a laptop computer to apply for and receive a card at mobile card issue system 101.

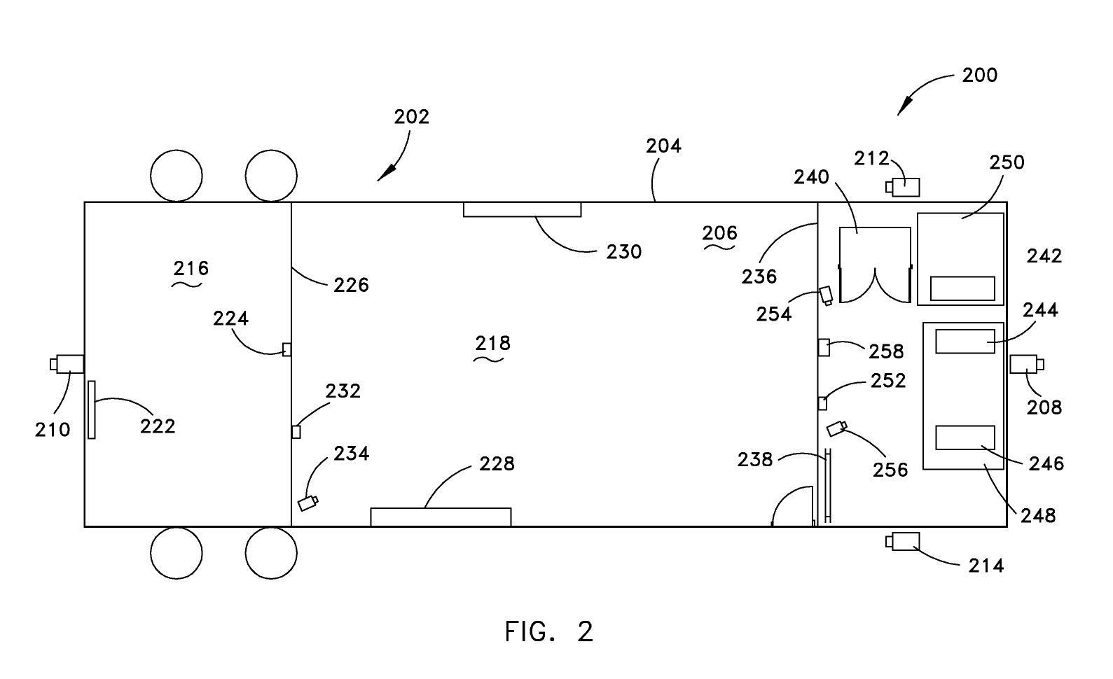

A further embodiment of the remote card issue system of the present invention is shown in FIG. 2. As shown in FIG. 2, the system 200 can be housed within a trailer 202 or other mobile container that includes multiple compartments. Trailer 202 has an exterior 204 and an interior 206. Exterior 204 may include a plurality of security cameras including a front view camera 208, a rear view camera 210, and one or more side view cameras 212 and 214. Interior 206 may include a plurality of compartments including a trunk compartment 216, work space 218, and a processing compartment 220.

Trunk compartment 216 may be configured for storage or other such use and includes a door 222 for accesses to the compartment. For security, a wired motion detector 224 may be positioned on the interior of trunk compartment 216 to allow monitoring of persons entering the compartment. A wall 226 is provided to separate trunk compartment 216 from work space 218. Wall 226 is shown as a solid wall but may, in some embodiments, include a door or opening permitting access to the trunk compartment 216 from work space 218 and vice versa.

Work space 218 may generally include an area sufficient for issuer staff to have work stations at which they can assist credit applicants, enter data, and perform other tasks. Work Space 218 may include a door 228 with a wireless contact coupled to a security monitoring system, and a window 230 for interacting with customers. A wired motion detector 232 and a security camera 234 may be provided and configured to aid in monitoring activity in work space 218. Wall 236 may be provided to separate workspace 218 from processing compartment 220. A door 236, shown as a cage door, may be provided to facilitate secured access to the processing compartment 220. Door 236 may have a wireless door contact coupled to a security system.

Processing compartment 220 may include a cabinet 240 for storage of locally housed equipment such as a digital video reorder (DVR) configured to locally store footage from one or more of the plurality of security cameras. In addition, the DVR may be configured to periodically push video data to storage device at another location to provide added security. Cabinet 240 may also house a GPS receiver (coupled to an antenna positioned on the roof of trailer 202), and other communications equipment. A variety of other security and office equipment may be provided in processing compartment 220. For example, a shredder 242 may be provided to destroy sensitive hard documents that are to be disposed of. A safe 244 may be provided to securely store blank cards for printing, credit applications, and other sensitive documents. A printer 246 is provided to print permanent cards for issuance. An additional printer may be provided to allow creation of various documents including credit applications, terms and conditions disclosures, and other documents. Work tables 248 and 250 may also be provided to allow issuer employees or contractors with areas for working with the various documents. Processing compartment 220 may be monitored by a motion sensor 252 in communication with a security system, and one or more cameras 254 and 256. A security system panel 258 may be provided for access and control of the security system. In particular, the embodiment of FIG. 2 can comply with applicable PCI standards. While such standards are important for some embodiments, compliance is not required in all embodiments of the present invention. It should be noted that while wired or wireless sensors are disclosed, one type of sensor may be substituted for the other when appropriate.

The remote card issue system of any embodiment can be located or housed in a mobile container such as a trailer. By way of example only, a gooseneck trailer from FEATHERLITE TRAILERS, such as the 4941 Car Trailer, can be used with any embodiment of the present invention such the embodiments shown with respect to FIGS. 1 and 2.

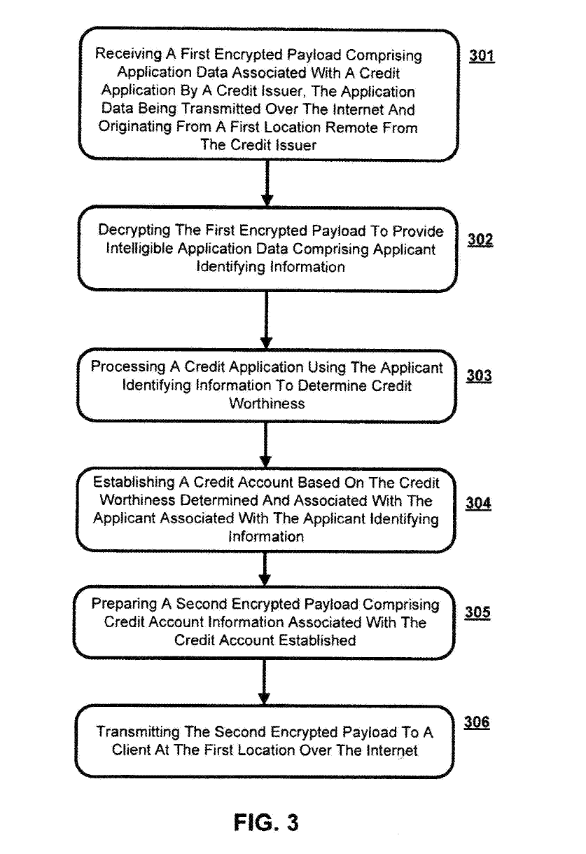

By way of another example, an embodiment as show in FIG. 3 provides a method for establishing a credit account. The method includes receiving 301 a first encrypted payload by a credit issuer from a client at a first location that is remote to the credit issuer. In some embodiments, the remote location is not under the direct control of the credit issuer. As used herein, “direct control” means having the power to control the activities of the business housed at the location. For example, in situations where the first location is a retailor issuing branded credit cards, the retailor would not be considered to be under the direct control of the credit issuer (i.e., a bank or other credit institution). The first encrypted payload may comprise application data associated with a credit application. The application data may be transmitted over the Internet and originate from the first location. The first payload may be decrypted 302 to provide intelligible application data comprising applicant identifying information using known cytological techniques. In particular, the encryption used herein may include multi-layer/multi-key encryption techniques, DES, AES256, SSL, and/or other known encryption techniques. In some embodiments, both the client (i.e., the party at the remote location) and the host (i.e., the credit issuer) may both possess and utilize private keys.

After receipt and decryption of the application, the data may be used to process 303 a credit application using the applicant identifying information to determine credit worthiness. Once satisfactory credit worthiness is determined, a credit account may be established 304 based on the credit worthiness determined and associated with the applicant identifying information. Information regarding the account established that is sufficient to permit the possessor of the information to initiate a transaction (such as a purchase) may then be prepared 305 in a second encrypted payload. The second encrypted payload may then be transmitted 306 to a client device at the first location over the Internet.

The client device at the first location decrypts the second encrypted payload to provide intelligible credit account data and updates or creates a token uniquely associated with the credit account based on the credit account data at the first location. In some embodiments, the token comprises a card (such as a credit card), computer chip, magnetic media (such as a credit card strip), or computer readable code configured to instruct a device to display an image (such as a QR or other bar code) or generate and transmit a signal (such as an RF signal), or a component of a digital wallet application and/or device. In some embodiments, the account holder may already have an account with the credit issuer. In some such cases an existing token may be updated rather than creating an entirely new token (e.g., a new card for an existing account may be provided). In particular embodiments, the client device may be a credit card printer configured to emboss and print account data on plastic credit cards and to encode account data on a magnetic strip.

In some embodiments, the card printer may be configured to print a customizable image on the credit cards. Such images may be provided via an application, uploaded, or sent through email or other messaging system by the applicant and printed on the face of the card. In some of these embodiments, the image provided by the applicant may be screened electronically or manually to determine if the image complies with issuer guidelines. Such guidelines may prohibit the printing of copyrighted material or images that are scandalous, profane, or otherwise not suitable for combination with an issuer mark on a card.

In combination with other security features, the client device may include a permanent or semi-permanent identifier associated with the client device and stored on the client device, the identifier being valid only when the client device is positioned at the first location. The identifier may be an IP address, MAC address, or other unique identifier capable, for example, of determining if the client device is on a network at a particular location. In some embodiments, the remote location may be a parked vehicle having all necessary connectivity and equipment.

In further embodiments, a relay may be used to route communications between the client and host. The relay may be controlled by a third party or the credit issuer and include middleware for the secure decryption of routing information from one or both of the client and host and then routing the information to the other of the client and host. Typically, the client and host may utilize dynamic key exchange.

In a typical, but non-limiting, implementation, a web-based application may be provided by the credit issuer that is hosted on one or more servers operated by the credit issuer. The web based application may be used by a retailor or other party to securely enter applicant information and submit it to the credit issuer for purposes of determining credit worthiness. In some of these and other embodiments, communication with the credit issuer may be done using a virtual private network (“VPN”) or other secured connection.

In some embodiments, a method of establishing a credit account may include collecting application data associated with a credit application for a credit issuer. The application data may be transmitted over a WAN, such as the Internet, and from a first location not directly controlled by the credit issuer. The collected application data is then encrypted and transmitted to the credit issuer using any of the methods described herein. After a determination of creditworthiness is made by the credit issuer, an encrypted payload may be received, via the Internet, by the client. The encrypted payload can comprise credit account information associated with a credit account established by the credit issuer based on the application data. The payload is decrypted to provide intelligible credit account data. A token associated with the credit account may be updated or created based on the credit account data at the first location.

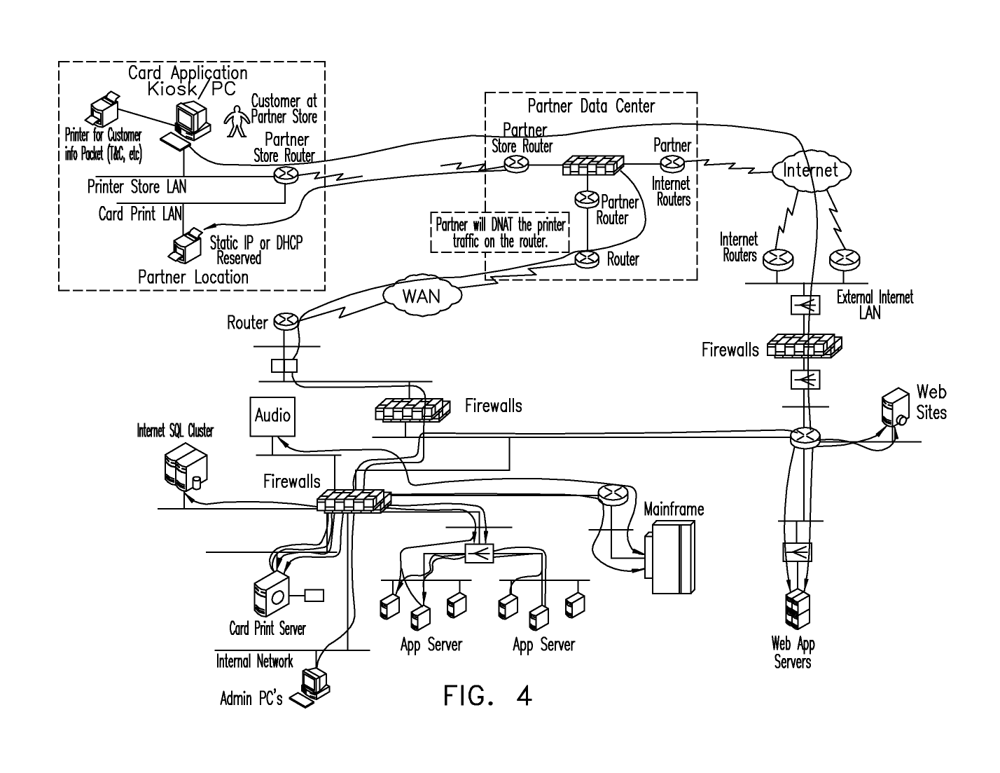

Referring to FIG. 4, a remote card issuance system and method may be implemented at a partner location such as a retail store or other facility wishing to have a co-branded credit token or card.

While the invention has been described in detail in connection with specific embodiments, it should be understood that the invention is not limited to the above-disclosed embodiments. Rather, the invention can be modified to incorporate any number of variations, alternations, substitutions, or equivalent arrangements not heretofore described, but which are commensurate with the spirit and scope of the invention. Specific embodiments should be taken as exemplary and not limiting.

We claim:

1. A method for establishing a credit account, the method comprising:
receiving a first encrypted payload comprising application data associated with a credit application by a credit issuer, the application data being transmitted over the Internet and originating from a first location remote from the credit issuer;
decrypting the first encrypted payload to provide intelligible application data comprising applicant identifying information;
processing a credit application using the applicant identifying information to determine credit worthiness;
establishing a credit account based on the credit worthiness determined and associated with the applicant associated with the applicant identifying information;
preparing a second encrypted payload comprising credit account information associated with the credit account established;
transmitting the second encrypted payload to a client at the first location over the Internet; and
wherein, a client device at the first location decrypts the second encrypted payload to provide intelligible credit account data and updates, replaces, or creates a token uniquely associated with the credit account based on the credit account data at the first location.

2. The method of claim 1, wherein the token comprises a card, chip, magnetic media, or computer readable code configured to instruct a device to display an image or generate and transmit a signal.

3. The method of claim 2, wherein the token comprises a computer readable code configured to instruct a device to display a computer readable image.

4. The method of claim 1, wherein the first and second encrypted payloads are encrypted using multi-key encryption.

5. The method of claim 4, wherein at least one of the keys provided by each of the client and the credit issuer are private keys.

6. The method of claim 5, wherein the client device includes a permanent or semi-permanent identifier associated with the client device and stored on the client device, the identifier being valid only when the client device is positioned at the first location.

7. The method of claim 1, wherein the token comprises a plastic credit card, and the step of updating or creating is done by a printer configured to emboss or print account information on a plastic credit card.

8. The method of claim 1, wherein the first location comprises a vehicle having physical security measures sufficient to comply with PCI standards.

9. The method of claim 1, wherein the first encrypted payload is routed through a relay.

10. The method of claim 9, wherein the relay comprises a third party server.

11. The method of claim 9, wherein the client and the credit issuer communicate utilizing dynamic key exchange.

12. The method of claim 1, wherein the first location is not directly controlled by the credit issuer.

13. The method of claim 1, wherein the step of receiving a first encrypted payload is initiated via a web-based application hosted on one or more of a credit issuer's servers.

14. The method of claim 13, wherein the web-based application communicates with the one or more of the credit issuer's servers via a virtual private network.

15. A method of establishing a credit account, the method comprising:
collecting application data associated with a credit application for a credit issuer, the application data originating from a first location not directly controlled by the credit issuer;
encrypting the collected application data to create encrypted application data;
transmitting the encrypted application data to the credit issuer;
receiving an encrypted payload via the Internet, the encrypted payload comprising credit account information associated with a credit account established by the credit issuer based on the application data;
decrypting the payload to provide intelligible credit account data; and
updating or creating a token uniquely associated with the credit account based on the credit account data at the first location.

16. The method of claim 15, wherein the token comprises a card, chip, magnetic media, or computer readable code configured to instruct a device to display an image or generate and transmit a signal.

17. The method of claim 16, wherein the token comprises a computer readable code configured to instruct a device to display a computer readable image.

18. The method of claim 15, wherein encryption is carried out using multi-key encryption.

19. The method of claim 18, wherein at least one of the keys provided by each of the client and the credit issuer are private keys.

20. The method of claim 19, wherein the client device includes a permanent or semi-permanent private key associated with the client device and stored on the client device, the key being activated only when the client device is positioned at the first location.

21. The method of claim 15, wherein the token comprises a plastic credit card, and the step of updating or creating is done by a printer configured to emboss or print account information on a plastic credit card.

22. The method of claim 15, wherein the first location comprises a vehicle having physical security measures sufficient to comply with PCI standards.

23. The method of claim 15, wherein the first encrypted payload is routed through a relay.

24. The method of claim 23, wherein the relay comprises a third party server.

25. The method of claim 23, wherein the client and the credit issuer communicate utilizing dynamic key exchange.

26. The method of claim 15, wherein the first location is not directly controlled by the credit issuer.

27. The method of claim 15, wherein the step of receiving a first encrypted payload is initiated via a web-based application hosted on one or more of a credit issuer's servers.

28. The method of claim 27, wherein the web-based application communicates with the one or more of the credit issuer's servers via a VPN.

29. A method for establishing a credit account, the method comprising:
receiving a first encrypted payload comprising application data associated with a credit application by a credit issuer, the application data being transmitted over a network and originating from a first location remote from and not directly controlled by the credit issuer;
decrypting the first encrypted payload to provide intelligible application data comprising applicant identifying information;
processing a credit application using the applicant identifying information to determine credit worthiness;
establishing a credit account based on the credit worthiness determined and associated with the applicant associated with the applicant identifying information;
preparing a second encrypted payload comprising credit account information associated with the credit account established;
transmitting the second encrypted payload to a client at the first location over the Internet; and
wherein, a client device at the first location decrypts the second encrypted payload to provide intelligible credit account data and updates, replaces, or creates a token uniquely associated with the credit account based on the credit account data at the first location.
